(19) United States
(12) Patent Application Publication
(10) Pub. No.: US 2013/0101720 A1
(43) Pub. Date: Apr. 25, 2013

(54) METHOD FOR COOKING WITH STEAM

(71) Applicant: Pascal M. Allaire, Torrance, CA (US)

(72) Inventor: Pascal M. Allaire, Torrance, CA (US)

(21) Appl. No.: 13/655,271

(22) Filed: Oct. 18, 2012

Related U.S. Application Data
(60) Provisional application No. 61/549,008, filed on Oct. 19, 2011.

(51) Int. Cl. A23L 1/015

(52) U.S. Cl. CPC A23L 1/0151
USPC 426/510

(57) ABSTRACT

Methods for steaming food are disclosed. Food suspended within a compartment of the apparatus is cooked by steam rising from a reservoir of boiling water below. The water boils by way of a heating element. After passing through the food compartment, steam collects in a dome shaped lid where it condenses to water which then flows by means of a gutter device below the lid into channels along the food compartment walls to return to the reservoir without contacting the food.

### CROSS-REFERENCE TO RELATED APPLICATIONS

This application claims priority to United States Provisional Patent Application No. 61/549,008, filed Oct. 19, 2011, the entirety of which is incorporated herein by reference.

### BACKGROUND OF THE INVENTION

1. Field of the Invention

This invention relates to methods for cooking food with steam. The benefits of cooking with steam as opposed to alternative methods are appreciated by many concerned with the nutritive value as well as the aesthetic qualities of food.

2. Description of the Related Art

Raw foodstuffs such as meats and vegetables are made up of cells which have high water content. When such foods are cooked under dry conditions, as when baked, they lose intrinsic moisture and may become less palatable and less attractive. When food is cooked by immersion in boiling water, the water in the food cells will expand and also boil, breaking down cell membranes and walls. The result is not only deterioration in texture but also a loss of flavor and color as soluble cell contents are diluted away.

Food items also may contain undesirable materials. Some foods are treated with pesticides or preservatives, which many people prefer not to consume. These are often lipophilic materials that are difficult to remove without surfactants. However, surfactants themselves can alter the food or leave undesirable flavors behind. Food items can also have bacteria, protozoa, or other pathogens on them, which may or may not be removed by typical rising steps. It would be desirable to remove or inactivate such pathogens without damaging or altering the food items or the flavor of food items. Finally, some foods contain strong flavors or odors that can be transferred to other foods when they are cooked together. It would be desirable to be able to cook food items together without the transfer of these flavors or odors.

Even at room temperature, the quality of food is affected when it is immersed in water. Osmotic effects will cause cells to expand and rupture in hypotonic environments and to shrink in those that are hypertonic. Equilibrium forces cause a redistribution of ions and small molecules between intercellular and extracellular compartments which can be detrimental to flavor and nutritive value. These effects proceed more rapidly as the temperature is increased, and are most apparent when food is heated above the boiling point of water.

An ideal cooking method would cook food in a moist atmosphere, below the boiling point of water, and without allowing it to become saturated with water. Existing cooking devices, such as the double boiler, the pressure cooker and variants of vessels containing racks to suspend food over boiling water do not achieve all of these objectives.

A double boiler consists of a pot for holding food which is nested into another pot containing boiling water. The food is out of contact with water and the temperature in the upper pot cannot exceed the steam temperature, however, since the steam does not penetrate the food but only contacts the exterior of the cooking pot, the method is only suitable for heating liquids, which can conduct and distribute the heat. Food cooked on a rack in a pressure cooker is penetrated by steam and suspended above the water level; however, the purpose of this method is to reduce cooking times, a purpose achieved by increasing the pressure so that the temperature can be raised above the atmospheric boiling point of water. Such temperatures, even in the absence of boiling, can adversely affect food textures. The simple process of cooking food over boiling water on a rack in a covered vessel comes close to the ideal method, but in practice, steam condenses on the inside of the vessel lid and drips back into the food. Since condensate is cooler than the steam, it interrupts the cooking process in local regions where it falls and the cooked food lacks uniform texture. Further, soluble constituents of the food are leached away as condensate percolates down through. Those soluble constituents, including undesirable flavors, odors, or contaminants, could be redeposited on other food items. The double boiler and pressure cooker devices suffer these drawbacks as well.

U.S. Pat. No. 4,739,698 and PCT Publication No. WO 2008/100788, herein incorporated by reference in their entireties, disclose apparatuses and methods for cooking food with steam. The present invention is related to improved methods of cooking with steam.

### SUMMARY OF THE INVENTION

In one embodiment, a method of steaming food is provided, comprising heating water in a reservoir to generate steam in a cooking apparatus; directing the steam upward through a food compartment to a convex lid in the cooking apparatus, thereby steaming the food compartment and forming condensed water on the convex lid; allowing the condensed water on the convex lid to drain into a gutter; directing the condensed water in the gutter to a base compartment through at least one enclosed channel located along the food compartment, thereby avoiding contact between the condensed water and the food compartment; and capturing the condensed water in a base compartment, wherein the food compartment comprises at least one food item, and wherein heating the water comprises controlling the temperature of the water such that the temperature of the at least one food item does not exceed about 211° F.

In some embodiments, the temperature of the food compartment does not exceed about 211° F. In some embodiments, the water in the reservoir is ionized water. In some embodiments, the pH of the water is about 11-12. In some embodiments, the convex lid is a dome-shaped lid. In some embodiments, heating the water comprises the use of a resistive heating device that converts electricity to heat. In some embodiments, the steam evenly heats the food compartment. In some embodiments, the temperature of the air throughout the food compartment does not differ by more than 10° F. In some embodiments, the reservoir and the base compartment are the same structure.

In a particular embodiment, food items are pretreated by disinfecting with a low pH rinse (e.g., with water at about pH 2-3, preferably about pH 2.5), which then can be followed by an aqueous rinse with high pH water (e.g., water at about pH 11-12). The high pH rinse can remove lipophilic materials and other materials that may be contaminating the outside of the food product, including bacteria, viruses, metals, pesticide residues, preservatives, and other such compounds.

In another embodiment, a method of preventing cross-contamination when steaming food is provided, comprising heating water in a reservoir to generate steam in a cooking apparatus; directing the steam upward through a food compartment to a convex lid in the cooking apparatus, thereby steaming the food compartment and forming condensed water on the convex lid; allowing the condensed water on the convex lid to drain into a gutter; directing the condensed water in the gutter to a base compartment through at least one enclosed channel located along the food compartment, thereby avoiding contact between the condensed water and the food compartment; and capturing the condensed water in a base compartment, wherein the food compartment comprises at least two food items.

In some embodiments, the at least two food items comprise a meat item and a non-meat item. In some embodiments, the temperatures of each of the at least two food items do not exceed about 212° F. In some embodiments, the temperature of the food compartment does not exceed about 212° F. In some embodiments, the water in the reservoir is ionized water. In some embodiments, the pH of the water is about 11. In some embodiments, the convex lid is a dome-shaped lid. In some embodiments, the steam evenly heats the food compartment. In some embodiments, the temperature of the air throughout the food compartment does not differ by more than 10° F., preferably not by more than about 2° F. In some embodiments, the reservoir and the base compartment are the same structure.

In one embodiment, the apparatus comprises a base compartment having a bottom and substantially vertical sides to contain water, a heating element to heat the water, a food compartment supported by the base compartment having a bottom which is perforated, a lower section inside the base compartment, essentially vertical side walls, a top and an upper section outside of the base compartment and above the base compartment, a lid on the top of the food compartment to collect and condense water vapor above the food compartment, at least one enclosed channel in the side wall of the food compartment having a first open end at the upper edge of the food compartment and a second open end below the perforated bottom, a gutter near the top of the food compartment to collect condensed water vapor from the lid and divert it into the first open end of the enclosed channel, the gutter and the channel acting to transfer condensed water vapor from the lid to the base compartment thereby avoiding contact of water with the food. In some embodiments, the bottom of the base compartment comprises two layers of material spaced apart from each other and a lid that is dome shaped.

In another embodiment, the food compartment may contain within the upper section a tray having a perforated bottom. In some embodiments, the perforations in the tray will be smaller than the perforations in the bottom of the food compartment.

In still another embodiment, the gutter may be a flat strip lying below the lid having an aperture, having an outer edge in contact with the periphery of the lid and inner edge bearing a vertical lip, having a width at least the diameter of the vertical channel of the food compartment below, and sloping downwardly from inner edge to outer edge. Optimally the gutter may be affixed to the lid and there may be provided a mechanical index to align the aperture of the gutter with the channel below.

In another embodiment, the base compartment and the food compartment are essentially cylindrical in shape.

In accordance with another aspect of the present invention there is provided an improvement in an apparatus for cooking food in steam by suspending food above boiling water, the improvement comprising a means for condensing steam above the food, a means for collection the condensed steam, and a channel for carrying the collected condensed steam down past the food while avoiding contact between the food and the condensed steam.

In accordance with yet another aspect of the present invention there is provided a method of cooking food with steam, comprising placing food in a container having perforations therethrough, allowing steam from a heated reservoir below the food to pass through the food, trapping the steam above the food and condensing it to water, and transferring the water to the reservoir by way of a channel formed in the side of the container so that the water does not contact the food. In an embodiment, the water has a pH of about 8 to about 13. In an embodiment, the water has a pH of about 9.5 to about 11.5. In an embodiment, the water is substantially free of chlorine.

As one of skill in the art will recognize, the methods described herein can utilize the apparatuses described herein.

### BRIEF DESCRIPTION OF THE DRAWINGS

The accompanying drawings show an apparatus for cooking food with steam in accordance with one preferred embodiment of the present invention.

FIG. 1 is a side elevational view of the assembled apparatus.

FIG. 2 is an exploded perspective view of the apparatus, showing the individual components aligned in the order of their assembly, and with walls cut away to reveal internal features.

FIG. 3 is a fragmentary enlarged vertical section of the central part of the assembled apparatus.

FIG. 4 is a fragmentary enlarged vertical section of the side wall and bottom of the assembled apparatus.

FIG. 5 is a front elevational view of an embodiment of the assembled apparatus.

FIG. 6 is a front elevational view of another embodiment of the assembled apparatus.

FIG. 7 is a side elevational view of another embodiment of the assembled apparatus.

### DETAILED DESCRIPTION OF THE PREFERRED EMBODIMENT

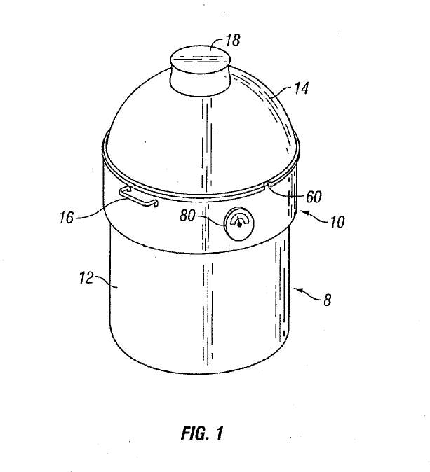

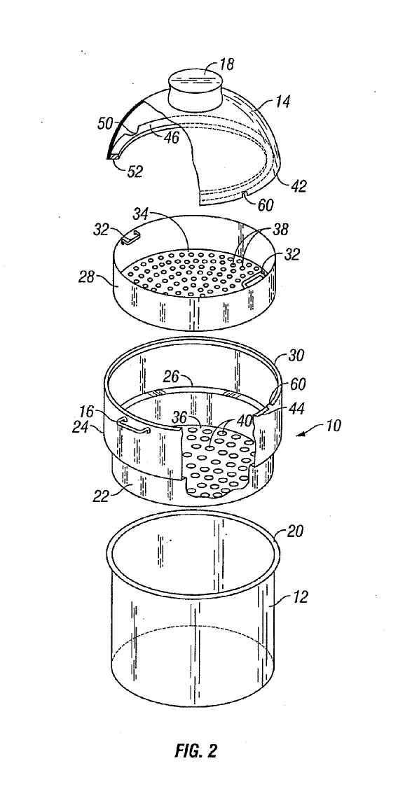

FIG. 1 and FIG. 2 show an embodiment of a cooking apparatus that can be used in the methods of the invention, which is a cooking apparatus 8 comprising two cylindrically shaped compartments with substantially vertical sides, an upper food compartment 10 nested into a water reservoir 12 below. In some embodiments, the water reservoir may be heated using a heating element attached thereto. The food compartment 10 is covered by a dome-shaped lid 14, and has handles 16 permanently attached to the side walls to facilitate its handling. The lid also has a handle 18 preferably mounted at its apex.

In one embodiment, the cooking apparatus further comprises a thermometer to measure the temperature of the water or the steam. As shown in FIG. 1, the thermometer 80 may be placed on a region of the food compartment 10 to measure the temperature of the steam that is cooking the food. In another embodiment (not shown), a thermometer may be placed in the reservoir to measure the temperature of the water. One of ordinary skill in the art can use the temperature values to determine if additional heat or a lesser amount of heat needs to be applied to the water in the reservoir. If insufficient heat is present, then the food will not cook properly. If too much heat is present, then the cells of the food may become damaged and important enzymes within the food may be lost.

FIG. 2 shows the detailed construction of each of the components of this embodiment. The reservoir 12 has a lip 20 at its upper edge which supports the food compartment 10 when the apparatus is assembled. The food compartment 10 comprises a lower section 22 and an upper section 24. The lower section 22 of the food compartment is smaller in diameter than the reservoir 12 and the upper section 24 is larger in diameter than the reservoir 12. The lower section 22 is deep enough to nest securely in the reservoir 12 and is less deep than the upper section 24; however, in various embodiments it may be of equal or greater depth. It is also possible to eliminate the lower section and still retain the features of the invention. The two sections of the food compartment 10 meet at a shoulder 26 which in this embodiment serves as a support for an optional tray 28. The shoulder 26 also serves to support the food compartment 10 above the reservoir 12. Alternatively, the tray could be suspended from a rim 30 (which is provided at the top of the food compartment 10) by projecting tabs or similar devices (not shown). The tray 28 may also be of cylindrical shape and has a diameter intermediate between those of the upper 24 and lower 22 sections of the food compartment 10. Handles 32 are fixed to the interior walls of the tray 28 to facilitate its insertion and removal. A food compartment bottom 34 and a tray bottom 36 are provided, respectively, in the food compartment 10 and the tray 28. Both bottoms 34, 36 are perforated to allow steam to pass through from below. The tray bottom perforations 38 are preferably smaller than the food compartment bottom perforations 40. In some embodiments, the perforations 38 of the food compartment bottom 32 are 3/16 inch in diameter spaced ⅛ inch apart and the perforations of the tray bottom 34 are ⅛ inch in diameter spaced 3/16 apart. In addition to perforated metal, mesh or similar material having holes therethrough may be used for the tray bottom 34 and the food compartment bottom 32.

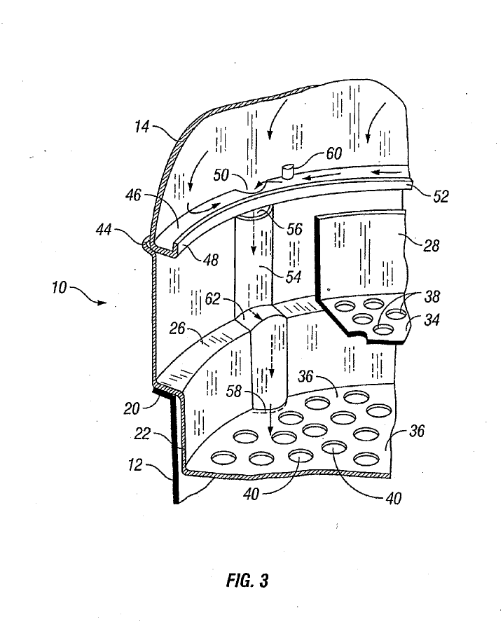

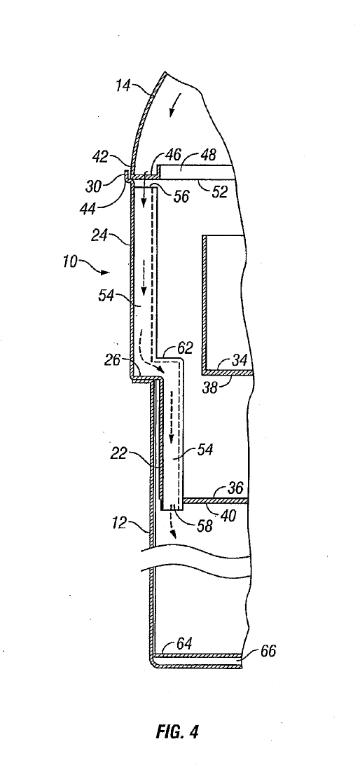

The domed lid 14 has a diameter at its lower periphery 42 corresponding to that of the food compartment 10 and seats on an L-shaped lip 44 of its rim 30. Other mating conformations of lid periphery 42 and rim 30 are acceptable which allow a seal that substantially retains the water vapor within without increasing internal pressure. Also, at the lower periphery of the lid 42 a ledge 46 extends inward and centrally for a short distance to terminate in a vertical lip 48 as seen in FIG. 3 and FIG. 4. At least one aperture 50 along its length allows the ledge 46 to act as a gutter 52, collecting condensed moisture running down the interior surface of the lid and diverting it into at least one channel 54 running downward along the wall of the food compartment 10 below. The width of the gutter 52 may be approximately equal to the width of a first open end 56 of the channel 54 and the dimensions of its apertures are preferably less than the cross-sectional dimensions of the channels so that water does not flow down outside the channels. When the entire cooking apparatus 8 is on a level surface, the gutter 52 preferably slopes along its length down toward the aperture or apertures 50 to direct condensed water vapor into the channels 54. The gutter 52 may either be integral with the lid as shown in this embodiment or it may be a separate component to be placed between the lid 14 and the food compartment 10. In either case an externally placed mechanical index 60 such as a detent may be used to align gutter apertures 50 with intake openings 56 of channels 54 below. Alternatively, the gutter may be integral with the side wall of the food compartment, and no aligning device would be required.

FIG. 3 and FIG. 4 show one of the enclosed channels 54 of the food compartment 10 which carry condensed water vapor from the gutter 52 above past the food in the compartment 10 and into the reservoir 12 at the bottom. Channels may be formed by attaching rounded strips of materials to the interior walls of the food compartment 10 by welding or other means of permanent bonding so as to seal the lateral edges. The channels 54 are essentially vertical in orientation having an open intake end 56 just below the rim 30 and an open discharge end 58 below the perforated bottom panel 32, and in this embodiment have a right angled dogleg 62 at the shoulder where the upper 24 and lower 22 sections meet.

The reservoir 12 in this embodiment has a two-layered bottom panel 64 in which a gap 66 of approximately ¼ inch separates the layers. The channels 54 are bounded by the curved wall of the food compartment 10 and the rounded strips and are essentially elliptical in horizontal cross-section.

In operation this apparatus allows steam generated from boiling water in the reservoir to pass through the food compartment 10 through perforations 36, 38 in the bottom panels of the compartment 10 and auxiliary tray 28, raising the temperature of the food contained therein and cooking it. After passing through the food compartment, steam is trapped in the dome-shaped lid 14 and condenses to water on its inner surface. FIG. 3 and FIG. 4 show the route of the condensed water vapor from the inner surface of the lid 14 back to the reservoir 12. The water flows down to be collected in the gutter 52. The slope of the gutter 52 assists in diverting the flow through apertures 50 lying above the open ends 56 of channels 54 in the walls of the food compartment below. By means of these channels 54, steam condensed to water after passing through the food compartment 10, is returned to the reservoir 12 without coming into contact with the food.

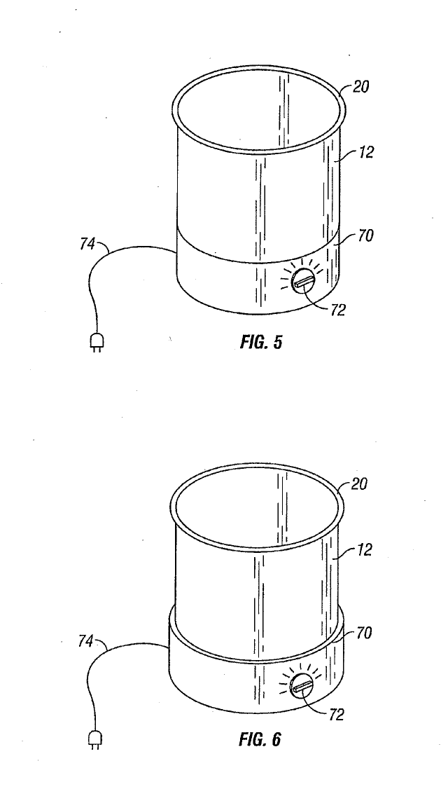

In some embodiments, the water is converted into steam by heat using a heating element that is attached to the reservoir, as shown in FIG. 5 and FIG. 6. The heating element 70 may comprise a resistive heating device that converts electricity into heat. As shown in FIG. 5, the reservoir 12 may itself comprise the heating element 70. In such an embodiment, the heating element is subsumed within the reservoir in a unitary structure. Alternatively and as shown in FIG. 6, the heating element 70 may be located so that it circumferentially surrounds the lower portion of the reservoir 12. The heating element 70 operates to heat the reservoir 12 in such a manner that the water contained within the reservoir 12 is converted to steam in order to cook the food contained in the food compartment 10 above the reservoir 12.

In some embodiments, the heating element 70 comprises an electrical cord 74 that may be used in conjunction with an electrical outlet of appropriate voltage. Such a device enables the cooking apparatus to be used in any area where an electrical outlet is available and allows for greater freedom in the manner in which the apparatus may be operated. Such a heating element 70 allows the cooking apparatus to be used in any room and also outdoors. In another embodiment, the electricity may be derived from a direct current, such as a battery.

In some embodiments, the heating element 70 may comprise an adjustable power switch 72. The adjustable power switch 72 may enable a user of the cooking apparatus to control the output of heat put out by the heating element 70. The adjustable power switch 72 may be marked with indicia to indicate varying level of heat. In some embodiments, the marks may include designations such as “low,” “medium,” and “high” heat. In some embodiments, the marks may use numerals of ascending order to guide the user as to the degree of heat provided by the heating element 70.

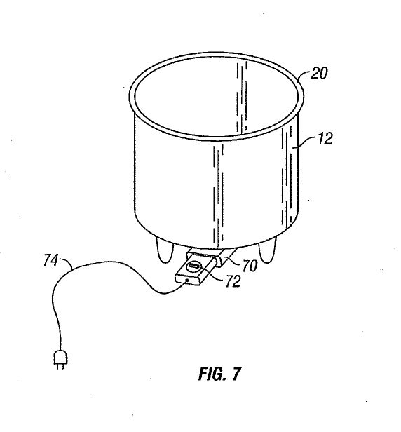

In some embodiments, and as shown in FIG. 7, the heating element 70 may be adjacent to and underneath the reservoir 12. In such an embodiment, the heating element 70 and the reservoir 12 may or may not be a unitary structure. In some embodiments, the heating element 70 may be detached from the reservoir 12. Once detached, the heating element 70 may be stored in a separate location or used in conjunction with another apparatus. In some embodiments, heating the water comprises the use of a structure selected from the group consisting of a structure subsumed within the reservoir, a structure that circumferentially surrounds the reservoir, and a structure adjacent to and underneath the reservoir.

In some embodiments, the water used in the cooking apparatus comprises water having a basic pH. For example, the water in the apparatus can have a pH of about 7 or more. Water pH selection is an important factor in obtaining good cooking results. In an embodiment, the water has a pH of about 8 to about 13, or more preferably, of about 9.5 to about 11.5. For example, in some embodiments, the pH of the water is about 8, 8.5, 9, 9.5, 10, 10.5, 11, 11.5, 12, 12.5, or 13. In an embodiment, the water has a pH of about 9 to about 12. In an embodiment, the water has a pH of about 9.5 to about 11.5. In an embodiment, the water has a pH of about 10 to about 11. In some embodiments, the water is substantially free of chlorine. Chlorine can be removed from the water using known filtration methods. Excellent cooking results can be achieved with chlorine-free water and/or water having a pH of about 8 to about 13.

The pH of the water can be adjusted using any number of methods. Acidic compounds and acidic foods lower the pH of the water, while basic compounds and basic foods raise the pH. Salts can have acidic or basic properties. The pH level of the water should be safe for consumption. Those having ordinary skill in the art, guided by the disclosure herein, can adjust the pH accordingly. Additionally, water generators may be used to supply water at a desired pH. For example, the Enagic Leveluk SD 501 Continuous Ionized Electrolysis Water System® can provide different levels of ionized water using filtration and electrolysis techniques. Water is first purified by running through the internal filter, and then ionized by the electrolysis process, splitting the water into two parts, one part alkaline and the other part acidic.

In an embodiment, a method of preparing food comprises placing food in the food compartment of the apparatus and water in the base compartment of the apparatus heating the water using the heating element to generate steam below the food. As steam is generated from the water below, it rises up within the cooking apparatus and passes through the food. As the steam continues to rise, it is trapped in the cooking apparatus above the food, where it condenses back into water. The condensed water can then be transferred back to the base compartment by way of a channel formed in the side of the container. Preferably, the water does not contact the food.

In some embodiments, the food is cleaned before it is placed in the cooking apparatus. For example, food, such as fish or vegetables, can be washed to remove unwanted bacteria before the food is cooked with steam. In an embodiment, the food is cleaned with water having a low pH, e.g., about 2.0 to 3.0, preferably about 2.5, followed by cleaning with water having a high pH, e.g., about 10.5 to about 12.0, preferably about 11.5, prior to placement in the food compartment. The low pH water rinse is used to sanitize the food, and the higher pH rinse removes lipophilic compounds. The Enagic Leveluk SD 501 Continuous Ionized Electrolysis Water System® is one suitable source of ionized water.

In some embodiments, the food compartment does not exceed a particular temperature. For example, in some embodiments, the temperature of the food compartment does not exceed about 210° F., 211° F., or 212° F. In some embodiments, the temperature of the food compartment does not exceed about 140° F., 145° F., 150° F., 155° F., 160° F., 165° F., 170° F., 175° F., 180° F., 185° F., 190° F., 195° F., 200° F., 205° F., 208° F., 209° F., 210° F., 211° F., or 212° F.

In some embodiments, a food item does not exceed a particular temperature. For example, in some embodiments, the temperature of a food item does not exceed about 212° F. In some embodiments, the temperature of a food item does not exceed about 140° F., 145° F., 150° F., 155° F., 160° F., 165° F., 170° F., 175° F., 180° F., 185° F., 190° F., 195° F., 200° F., 205° F., 208° F., 209° F., 210° F., 211° F., or 212° F.

In some embodiments, the steam evenly heats the food compartment. For example, in some embodiments, the temperature of the steam and/or of the food compartment does not differ by more than about 1° F., 2° F., 3° F., 4° F., 5° F., 6° F., 7° F., 8° F., 9° F., 10° F., 15° F., 20° F., or 25° F. throughout the food compartment.

In some embodiments, the steam evenly heats a food item. For example, in some embodiments, the temperature does not differ by more than about 1° F., 2° F., 3° F., 4° F., 5° F., 6° F., 7° F., 8° F., 9° F., 10° F., 15° F., 20° F., or 25° F. in a food item.

In some embodiments, the methods described herein reduce odors associated with steaming. In some embodiments, odors are reduced by reducing the formation of toxins. In some embodiments, odors are reduced by capturing steam containing toxins or odors, and by preventing the condensate from contacting the food items.

In some embodiments, the methods described herein reduce cross-contamination when steaming foods. This is because any water condensing on the food itself drips down, rather than running from one food item to another, and any water condensing on the lid of the cooking apparatus is directed down the side of the cooking apparatus and does not run across or drip on the food items. For example, the methods described herein can reduce cross-contamination between a meat item and a non-meat item, between two meat items, or between two non-meat items. In some embodiments, the meat item is beef, fish, poultry, seafood, sheep, pork, or lamb. In some embodiments, the poultry is chicken, duck, emu, goose, ostrich, turkey, or pheasant. In some embodiments, the non-meat item is a vegetable, fruit, grain, legume, or egg. In some embodiments, the grain is rice, wheat, oat, or barley.

In some embodiments, the methods described herein reduce the formation of heat zones in which temperatures rise to undesired levels. In some embodiments, heat in the food compartment is evenly distributed to prevent the formation of toxins. In some embodiments, heat in the food compartment is evenly distributed to preserve the nutritious elements, taste, or texture of food.

What is claimed is:

1. A method of preparing food, comprising:
selecting one or more food items;
sanitizing the food items by contacting them with low pH water;
removing lipophilic materials from the surface of the food items by contacting them with high pH water; then
placing the food items in a food compartment of a cooking apparatus
heating water in a reservoir to generate steam in the cooking apparatus;
directing the steam upward through the food compartment, thereby steaming the food compartment;
condensing the steam into water and directing the water into a base compartment of the cooking apparatus without permitting that water to contact the food items; and
controlling the temperature of the steam in the food compartment so that the one or more food items are maintained at a temperature below about 211° F.

2. The method of claim 1, wherein the water in the reservoir is ionized water.

3. The method of claim 1, wherein the pH of the ionized water is about 11-12.

4. The method of claim 1, wherein the cooking apparatus has a dome-shaped lid on which the steam is condensed.

5. The method of claim 1, wherein heating the water comprises the use of a resistive heating device that converts electricity to heat.

6. The method of claim 1, wherein the steam evenly heats the food compartment.

7. The method of claim 1, comprising maintaining the temperature of the food compartment within about 2° F.

8. The method of claim 1, wherein extraneous or deleterious substances are removed from the food by the sanitizing step, the step of removing lipophilic materials, and by preventing condensate from contacting the food items during cooking.

9. A method of preventing cross-contamination when steaming food, comprising:
heating water in a reservoir to generate steam in a cooking apparatus;
directing the steam upward through a food compartment to a convex lid in the cooking apparatus, thereby steaming the food compartment and forming condensed water on the convex lid;
allowing the condensed water on the convex lid to drain into a gutter;
directing the condensed water in the gutter to a base compartment through at least one enclosed channel located along the food compartment, thereby avoiding contact between the condensed water and the food compartment; and
capturing the condensed water in a base compartment,
wherein the food compartment comprises at least two food items.

10. The method of claim 9, wherein the at least two food items comprise a meat item and a non-meat item.

11. The method of claim 9, wherein the temperatures of each of the at least two food items do not exceed about 212° F.

12. The method of claim 9, wherein the temperature of the food compartment does not exceed about 212° F.

13. The method of claim 9, wherein the water in the reservoir is ionized water.

14. The method of claim 9, wherein the pH of the water is about 11.

15. The method of claim 9, wherein the convex lid is a dome-shaped lid.

16. The method of claim 9, wherein heating the water comprises the use of a resistive heating device that converts electricity to heat.

17. The method of claim 9, wherein the steam evenly heats the food compartment.

18. The method of claim 9, wherein the temperature of the air throughout the food compartment does not differ by more than 2° F.

19. The method of claim 9, wherein the reservoir and the base compartment are the same structure.
